(19) United States
(12) Patent Application Publication
(10) Pub. No.: US 2006/0151338 A1
(43) Pub. Date: Jul. 13, 2006

(54) Multi-function sensor system and method of operation

(76) Inventors: Da Yu Wang, Troy, MI (US); Walter T. Symons, Grand Blanc, MI (US); Robert Jerome Farhat, Grosse Pte Park, MI (US); Joachim Kupe, Davisburg, MI (US); David L. Ehle, Lapeer, MI (US); Alfred R. Webster, Grand Blanc, MI (US); Paul C. Kikuchi, Fenton, MI (US)

Correspondence Address: JIMMY L. FUNKE;DELPHI TECHNOLOGIES, INC., MAIL CODE; 480-410-202, P.O. BOX 5052, TROY, MI, 48007-5052, US

(21) Appl. No.: 11/034,125

(22) Filed: Jan. 12, 2005

(51) Int. Cl. G01F 1/64; G01N 27/26

(52) U.S. Cl. 205/780.5; 204/424

(57) ABSTRACT

A gas sensor system includes an ammonia-sensing cell for generating a signal upon exposure to an unknown gas comprising ammonia, an A/F cell for generating a signal upon exposure to hydrocarbons in the gas, a heater in thermal communication with the cells and a housing in which the cells and the heater are mounted. The housing permits an unknown gas to flow therethrough for contact with the cells, and there is a sensor control circuit in communication with the cells. The sensor control circuit is configured to utilize the signals from the cells to generate an ammonia concentration signal indicating the concentration of ammonia in the unknown gas. Ammonia may be sensed in an unknown gas by heating such cells to selected working temperatures, exposing them to an unknown gas, obtaining signals from the cells, and using the cell signals to determine the ammonia content.

### BACKGROUND

The automotive industry has used exhaust gas sensors in automotive vehicles for many years to sense the composition of exhaust gases, namely, oxygen. For example, a sensor is used to determine the exhaust gas content for alteration and optimization of the air-to-fuel ratio for combustion.

Exhaust gas generated by combustion of fossil fuels in furnaces, ovens, and engines, for example, contains nitrogen oxides (NO_{X}), unburned hydrocarbons (HC), and carbon monoxide (CO). Automobile gasoline engines utilize various pollution-control after treatment devices such as, for example, catalyst converters to reduce and oxidize NO_{X}, CO, and HC. The NO_{X} reduction is accomplished by using ammonia gas (NH₃) supplied by a urea tank, or by using HC and CO, which is generated by running the engine temporarily in rich conditions. The overall reaction for converting urea to ammonia is:
NH₂CONH₂+H₂O (steam)→2NH₃+CO₂
The product gas is a mixture of ammonia gas, and carbon dioxide (CO₂). In order for urea-based-SCR (special catalyst reaction) catalysts technologies to work efficiently, and to avoid pollution breakthrough, an effective feedback control loop is needed to manage the dosing of urea. To develop such control technology, there is an ongoing need for an economically-produced and reliable commercial ammonia sensor.

A need also exists for a reliable ammonia sensor for air ammonia monitoring in agricultural plants where ammonia is present in animal shades, and in all other industries where ammonia is produced or used, or is a by-product. Commercially available sensors typically suffer from lack of high sensitivity and selectivity. Thus, a widespread need exists for an improved ammonia gas sensor.

One type of sensor uses an ionically conductive solid electrolyte between porous electrodes. To sense oxygen, solid electrolyte sensors are used to measure oxygen activity differences between an unknown gas sample and a known gas sample. In the use of a sensor for automotive exhaust, the unknown gas is exhaust and the known gas, (i.e., reference gas), is usually atmospheric air because the oxygen content in air is relatively constant and readily accessible. This type of sensor is based on an electrochemical galvanic cell operating in a potentiometric mode to detect the relative amounts of oxygen present in an automobile engine's exhaust. When opposite surfaces of this galvanic cell are exposed to different oxygen partial pressures, an electromotive force (“emf”) is developed between the electrodes according to the Nernst equation.

With the Nernst principle, chemical energy is converted into electromotive force. A gas sensor based upon this principle may consist of an ionically conductive solid electrolyte material, a porous electrode with a porous protective overcoat exposed to exhaust gases (“exhaust gas electrode”), and a porous electrode exposed to a known gas' partial pressure (“reference electrode”). Many sensors used in automotive applications use a yttria-(fully or partially) stabilized zirconia-based electrochemical galvanic cell with porous platinum electrodes, operating in potentiometric mode, to detect the relative amounts of a particular gas, such as oxygen for example, that is present in an automobile engine's exhaust. Also, such a sensor may have a ceramic heater to help maintain the sensor's ionic conductivity. When opposite surfaces of the galvanic cell are exposed to different oxygen partial pressures, an electromotive force is developed between the electrodes on the opposite surfaces of the zirconia wall, according to the Nernst equation:

$$E = ( \frac{- RT}{4 F} ) ln ( \frac{{P}_{{O}_{2}}^{ref}}{{P}_{{O}_{2}}} )$$

where:
E=electromotive force
R=universal gas constant
F=Faraday constant
T=absolute temperature of the gas
P_{O}_{₂}^{ref}=oxygen partial pressure of the reference gas
P_{O}_{₂}=oxygen partial pressure of the exhaust gas

Due to the large difference in oxygen partial pressure between fuel rich and fuel lean exhaust conditions, the emf changes sharply at the stoichiometric point, giving rise to the characteristic switching behavior of these sensors. Consequently, these potentiometric oxygen sensors indicate qualitatively whether the engine is operating fuel-rich or fuel-lean conditions without quantifying the actual air-to-fuel ratio of the exhaust mixture.

For gas sensing based on electrochemical principle, other than the potentiometric mode, there is the ampere-metric (oxygen pumping) mode which can be used for exhaust equilibrium oxygen measurement or air to fuel ratio measurement. As taught by U.S. Pat. No. 4,863,584 to Kojima et al., U.S. Pat. No. 4,839,018 to Yamada et al., U.S. Pat. No. 4,570,479 to Sakurai et al., and U.S. Pat. No. 4,272,329 to Hetrick et al., an oxygen sensor which can operate in a diffusion limited current mode produces a proportional output which provides a sufficient resolution to determine the air-to-fuel ratio under fuel-rich or fuel-lean conditions.

In addition to detecting oxygen and/or other gas species, it is sometimes desired to control the temperature of the gas sensor. Since the impedance of a solid electrolyte gas sensor is temperature-dependent, some gas sensors can also be used as temperature sensors, by measuring the impedance of the electrolyte between the electrodes. A temperature sensor of this kind is disclosed in U.S. Pat. No. 4,463,594 to Raff et al.

There remains a need in the art for an improved ammonia sensor and for an improved multi-function sensor that can detect various gas species as well as temperature.

### SUMMARY OF THE INVENTION

A gas sensor system comprises an ammonia-sensing cell for generating an ammonia cell signal upon exposure to an unknown gas comprising ammonia, an A/F cell for generating an A/F cell signal upon exposure to hydrocarbons in the unknown gas, a heater in thermal communication with the ammonia-sensing cell and with the A/F cell, and a housing in which the ammonia-sensing cell, the A/F cell and the heater are mounted. The housing is configured to permit the flow of an unknown gas therethrough for contact with the ammonia-sensing cell and with the A/F cell, and there is a sensor control circuit in communication with the A/F cell and the ammonia-sensing cell, wherein the sensor control circuit is configured to utilize the ammonia cell signal and the A/F cell signal to generate an ammonia concentration signal indicating the concentration of ammonia in the unknown gas.

A method for sensing ammonia in an unknown gas comprises heating an ammonia-sensing cell and an A/F cell to selected working temperatures, exposing the ammonia-sensing cell and the A/F cell to an unknown gas, obtaining an ammonia cell signal from the ammonia-sensing cell, obtaining an A/F cell signal from the A/F cell, and using the ammonia cell signal and the A/F cell signal to determine the ammonia content of the unknown gas.

The above-described and other features will be appreciated and understood by those skilled in the art from the following detailed description, drawings, and appended claims.

### BRIEF DESCRIPTION OF THE DRAWINGS

Example sensors will now be described with reference to the accompanying drawings, which are meant to be illustrative, not limiting, and wherein like elements are numbered alike in several figures, in which:

FIG. 1 is an expanded perspective view of one embodiment of a sensor element;

FIG. 2 is a schematic elevational end view of the sensing end of the sensor element of FIG. 1;

FIG. 3 is a cross-sectional view of a sample gas sensor;

FIG. 4 is a schematic block diagram of the sensor element of FIG. 1 and a sensor circuit for use therewith;

FIG. 5 shows plots of the emf output of an ammonia-sensing cell, indicating ammonia gas concentrations on the horizontal axis and the emf output signal on the vertical axis for several different quantities of oxygen in the gas;

FIG. 6 shows plots of the emf output of an ammonia-sensing cell, indicating ammonia gas concentrations on the horizontal axis and the emf output signal on the vertical axis for several different quantities of water vapor in the unknown gas;

FIG. 7 is an expanded perspective view of a second embodiment of a sensor element; and

FIG. 8 is a schematic block diagram of the sensor element of FIG. 7 and an electronic control unit for use therewith.

### DETAILED DESCRIPTION OF INVENTION

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. Additionally, all ranges set forth herein are inclusive and combinable. For example, a range of up to about 500 micrometers (μm), e.g., a thickness of about 25 μm to about 500 μm; or a thickness of about 50 μm to about 200 μm, includes the ranges of about 25 μm to about 200 μm and about 50 μm to about 500 82 m, without the need for explicit statement thereof. The modifier “about” used in connection with a quantity is inclusive of the stated value and has the meaning dictated by the context (e.g., includes the usual degree of error associated with measurement of the particular quantity).

A gas sensor and sensor circuitry as described herein provide improved sensing of ammonia. The gas sensor includes a cell (i.e., electrodes disposed on opposite sides of an electrolyte for ionic communication from one electrode to the other via the electrolyte) capable of generating output signals responsive to ammonia (an “ammonia-sensing cell”) in an unknown gas (i.e., a gas of unknown ammonia content) to which the cell is exposed. The gas sensor also includes a cell capable of generating an output signal responsive to the oxygen and/or hydrocarbon in the unknown gas (an “A/F cell”), from which signal the air/fuel ratio of the gas can be determined. A sensor circuit in communication with the ammonia-sensing cell and the A/F cell processes signals emitted by those cells to determine the ammonia content of the gas. Optionally, one or more of the sensing cells and/or pump cells, e.g., the ammonia-sensing cell and/or the A/F cell, can be formed as separate sensor elements. Alternatively, all of the sensing cells comprise part of the same, monolithic sensor element. A method for sensing ammonia in the unknown gas can be carried out by exposing the ammonia-sensing cell and the A/F cell to the unknown gas and employing the signal from the A/F cell to obtain data reflecting the oxygen and water vapor content of the gas, which data can be employed with the signal from the ammonia-sensing cell to determine the ammonia gas content of the gas.

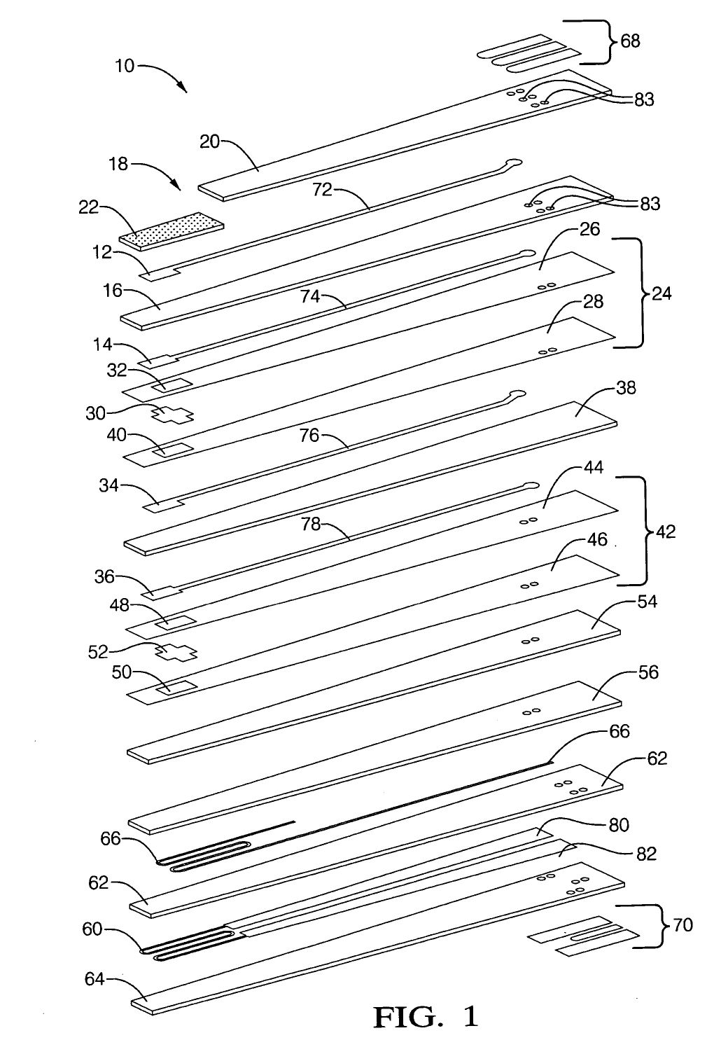

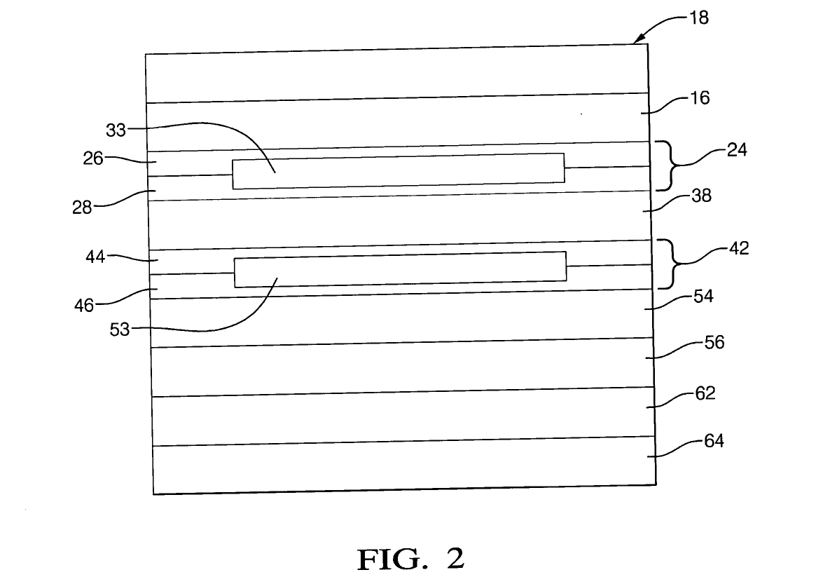

One embodiment of a sensor element for use with the described circuitry and method is illustrated in FIGS. 1 and 2. As described more fully below, sensor element 10 is a monolithic structure formed by the lamination of various layers that comprise an electrochemical ammonia-sensing cell (12/16/14), an electrochemical A/F cell and a heater, with first and second insulating layers between the electrochemical cells and the heater.

Electrochemical ammonia-sensing cell (12/16/14) comprises ammonia cell electrodes separated by an electrolyte for ionic communication therethrough. More specifically, ammonia-selective sensing electrode 12 and reference electrode 14 (the ammonic cell electrodes) are disposed on opposite sides of a solid electrolyte layer 16 (the ammonia cell electrolyte). On the side of sensing electrode 12 opposite solid electrolyte layer 16 is a protective layer 18, which optionally comprises a dense section 20 and a porous section 22 that enables fluid communication between sensing electrode 12 and the unknown gas (i.e., section 22 protects the electrode 12 from abrasion and/or poisoning while permitting the unknown gas to contact electrode 12).

Protective layer 18 is designed to protect the electrode 12 from contaminants, to provide structural integrity to the sensor element 10 and the electrode 12, and to allow the electrode 12 to sense ammonia gas without inhibiting the performance of the sensor element 10. Possible materials for protective layer 18 include alumina (such as, delta alumina, gamma alumina, theta alumina, and the like, and combinations comprising at least one of the foregoing alumina) as well as other dielectric materials.

The material forming sensing electrode 12 is reactive with ammonia in the unknown gas, and exposure of electrode 12 to ammonia in the unknown gas elicits an electrochemical reaction at electrode 12.

The sensing electrode 12 can comprise any ammonia-selective material compatible with the operating environment in which sensor element 10 will be used. Ammonia-selective materials comprise a primary material and a dopant secondary material. Suitable primary materials include one or more of vanadium oxides, tungsten oxides, and/or molybdenum oxides, and the like, such as one or more of vanadium pentoxide (V₂O₅), bismuth vanadium oxide (BiVO₄), copper vanadium oxide (Cu₂(VO₃)₂), Co₃(VO₄)₂, SmVO₄, CrVO₄, Ni₃V₂O₈, FeVO₄, AgV₇O₁₈, CeVO₄, Bi₅VO₁₀, CsVO₄, Bi_{0.5}Co_{0.5}VO₄, CeVO₄, Mn₂V₂O₇, tungsten oxide (WO₃), and/or molybdenum oxide (MoO₃). Any of these primary materials can be doped with secondary materials that can comprise metals and/or metal oxides that improve either the electronic or ionic electrical conductivity of the ammonia-selective material, or both, or that improve the NH₃ sensitivity and/or selectivity of the ammonia-selective material; these secondary materials include one or more of Na₂O, Li₂O, K₂O, MgO, BaO, Y₂O₃, La₂O₃, CeO₂, Er₂₂O₃, ZrO₂, Al₂O₃, ZnO, CdO, Ta₂O₅, CaO, SrO, SnO CuO, PbO, Sb₂O₃, Bi₂O₃, Nb₂O₅, Ta₂O₅, CrO₃, WO₃, and/or MoO₃.

An electrode connecting material is combined with a portion of the ammonia-selective material of sensing electrode 12 to facilitate the establishment of electrical continuity between the ammonia-selective material and a lead conductor such as lead 72. The electrode connecting material can comprise an electrically conductive metal and/or conductive metal oxide material with which a lead wire can easily make an electrical connection. Suitable electrically conductive metals include palladium (Pd), platinum (Pt), gold (Au), and the like, as well as alloys and combinations comprising at least one of the foregoing conducting metals, while possible electrical conducting metal oxides comprise oxides of one or more of barium (Ba), bismuth (Bi), lead (Pb), magnesium (Mg), lanthanum (La), strontium (Sr), calcium (Ca), copper (Cu), gadolinium (Gd), neodymium (Nd), yttrium (Y), samarium (Sm), iron (Fe), indium (In), titanium (Ti), and manganese (Mn), such as Ba₂O₂, CaO, Cu₂O, Ba₂CaCu₂ oxide, BiPbSrCaCu oxide, Ba₂Cu₃ oxide, LaSr (Co, Fe, In, Ti, and/or Mn) oxide (e.g., LaSrCu oxide, and the like), LaCo oxide, BiSrFe oxide, and the like. These electrode connecting materials can form composites with the ammonia-selective material by mutual intermixing or by simple physical contact with each other (by thin-film or thick-film deposition means) and thus enable the ammonia-selective material to make an electrical connection to a lead wire adequate to enable the measurement of an emf signal from the ammonia-sensing cell 12/16/14 to be made via the lead wire. To avoid affecting the emf generated by the ammonia-selective material of the sensing electrode 12, the electrode connecting material does not contact both the electrolyte layer 16 and the unknown gas. Therefore, the electrode connecting material, if it is in contact with the electrolyte layer 16, can be covered by an insulating layer (like top layer 20) to shield it from the unknown gas or, before the electrode connecting material is applied, an insulating layer (not shown) can be applied to the electrolyte where needed to prevent contact between the electrode connecting material and the electrolyte 16, in which case there is no need to shield the electrode connecting material from the unknown gas.

In one embodiment, the ammonia-selective material of sensing electrode 12 comprises vanadium oxide doped with an electrical conductivity dopant. For instance, when Bi₂O₃ is combined with V₂O₅ and fired, a new ammonia-selective material is formed having the formula BiVO₄. In such embodiments, the Bi (or other electrically conducting metal(s)/oxide(s)) is present in an amount of about 0.1 atomic percent (at %) to about 50 at %, optionally about 1 at % to about 50 at % and, in a particular embodiment, about 3 at % to about 50 at %, based on the number of doped metal atoms (e.g., Bi atoms) and the total number of metal atoms (e.g., V+Bi) in the ammonia-selective material. The Bi dopant is believed to lower the vapor pressure of V₂O₅ during the NH₃-sensing operation. In some embodiments, the metal atoms of an electrical conductivity dopant can comprise about 15 at % or less, optionally about 10 at % or less, in some embodiments, about 8 at % or less of the metal atoms in the ammonia-selective material. Such dopants can comprise one or more of zinc (Zn), iron (Fe), zirconium (Zr), lead (Pb), yttrium (Y), magnesium (Mg), cobalt (Co), sodium (Na), lithium (Li), calcium (Ca), and/or the like, as well as combinations comprising at least one of these dopants. All atomic percents are based upon the amount of the component in the formula.

In some embodiments, the electrical conductivity dopant can not only improve the conductivity of the ammonia-selective material, it can eliminate or ameliorate the green effect on the performance of the ammonia-sensing cell, and provide poison-resistance to the cell. The poison-impeding dopant(s) help to inhibit poisoning of the electrode by contaminants and can comprise zirconium (Zr), zinc (Zn), yttrium (Y), iron (Fe), sodium (Na), and/or lithium (Li), any one of which can be present singly or in combination with any one or more of the others, in an amount of about 0.1 at % to about 5 at %, optionally about 0.1 at % to about 3 at %, and in some embodiments, about 0.1 at % to about 1 at % of the ammonia-selective material. Stabilizing dopant(s) (such as tantalum (Ta) and niobium (Nb), and the like), which also help to eliminate or ameliorate the green effect, can be present in an amount of about 0.1 to about 15 at %. Alternatively, the collective amount of the chemically stabilizing metal(s) can comprise about 0.1 at % to about 5 at % of the formulation, optionally about 0.3 at % to about 5 at %, and in some embodiments, about 0.5 at % to about 5 at %, based upon the number of stabilizing metal atoms and the total number of metal atoms (inclusive of the stabilizing metal atoms) in the ammonia-selective material.

The ammonia-selective material for the sensing electrode 12 can be formed in advance of deposition onto the electrolyte layer 16 or can be disposed on the electrolyte layer 16 and formed during the firing of the sensor element.

In one embodiment, the ammonia-selective material is prepared and is disposed onto the electrolyte (or the layer adjacent the electrolyte). In this method, the primary material, preferably in the form of an oxide, is combined with the dopant secondary material and optional other dopants, if any, simultaneously or sequentially. By either method, the materials are preferably well-mixed to enable the desire incorporation of the dopant secondary material and any optional dopants into the primary material to produce the desired ammonia-selective material. For example, V₂O₅ is mixed with Bi₂O₃ and MgO and Ta₂O₅ by milling for about 2 to about 24 hours. The mixture is fired to about 800° C. to about 900° C. for a sufficient period of time to allow the metals to transfer into the vanadium oxide structure and produce the new formulation (e.g., BiTa_{0.05}Mg_{0.05}V_{0.95}O₄₋ₓ, (wherein x is the difference in the value between the stoichiometric amount of oxygen and the actual amount)), which is the reaction product of the primary material, secondary material and optional chemical stabilizing dopant, and/or diffusion impeding dopant. The period of time is dependent upon the specific temperature and the particular materials, but can be about 0.5 hours to 24 hours or so. Once the ammonia-selective material has been prepared, it can be made into an ink and disposed onto the desired sensor layer.

If an ink is employed, beside the above metals/oxides/dopants, it can also comprise binder(s), carrier(s), wetting agent(s), and the like, and combinations comprising at least one of the foregoing. The binder can be any material capable of providing adhesion between the ink and the substrate. Suitable binders include acrylic resin, acrylonitrile, styrene, acrylic acid, methacrylic acid, methyl acrylate, methyl methacrylate, and the like, as well as combinations comprising at least one of these binders. The carrier can include any material suitable for imparting desired printing and drying characteristics of the ink. In general, the carrier includes a polymer resin dissolved in a volatile solvent. The wetting agent can include ethanol, isopropyl alcohol, methanol, cetyl alcohol, calcium octoate, zinc octoate and the like, as well as combinations comprising at least one of the foregoing. For example, the ink can comprise about 10 weight percent (wt %) to about 30 wt % 1-methoxy-2-propanol acetate solvent, about 10 wt % to about 30 wt % butyl acetate solvent, about 5 wt % to about 10 wt % acrylic resin binder, zero wt % to about 5 wt % (e.g., 0.1 wt % to about 5 wt %) methyl methacrylate polymer, about 5 wt % to about 10 wt % ethanol wetting agent, and about 30 wt % to about 60 wt % of the sensing formulation, based upon the total weight of the ink.

In contrast to the sensing electrode 12, the reference electrode 14 can comprise any electrode material, i.e., it does not need to be sensitive to NH₃. The reference electrode 14 can comprise any catalyst capable of producing an electromotive force across the electrolyte layer 16 when the sensing electrode 12 contacts NH₃, including metals such as platinum, palladium, gold, osmium, rhodium, iridium, ruthenium,—and the like, as well as alloys, and combinations comprising at least one of the foregoing catalysts. A catalyst comprising platinum is preferred due to platinum having a processing temperature as high as the ceramic parts (1,400° C. and above), and being readily commercially available as an ink.

Fugitive materials, i.e., materials that degrade and leave voids in the electrode upon firing, can be employed in the electrode formulations to provide porosity to electrodes, e.g., a porosity sufficient to enable the ammonia to enter the electrode and reach triple points (points where the electrode, electrolyte, and ammonia meet to enable the desired reactions). Some possible fugitive materials include graphite, carbon black, starch, nylon, polystyrene, latex, other soluble organics (e.g., sugars and the like) and the like, as well as compositions comprising one or more of the foregoing fugitive materials.

With respect to the size and geometry of the sensing and reference electrodes 12, 14, they are generally adequate to provide current output sufficient to enable reasonable emf signal resolution over a wide range of ammonia concentrations. Generally, a thickness of about 1.0 micrometers to about 25 micrometers can be employed, for example, about 5 micrometers to about 20 micrometers, optionally about 10 micrometers to about 18 micrometers. The geometry of the electrodes can be substantially similar to the geometry of the electrolyte.

Electrodes can be formed using techniques such as chemical vapor deposition, screen printing, sputtering, and stenciling, with screen printing the sensing and reference electrodes onto appropriate tapes being preferred due to simplicity, economy, and compatibility with the subsequent firing process. For example, reference electrode 14 can be screen printed onto support layer 24 or over the electrolyte layer 16, and the sensing electrode 12 can be screen printed under porous protective layer 18 or over the electrolyte layer 16.

Electrolyte layer 16, like other electrolyte layers referred to herein, can comprise any material that is compatible with the environment in which the gas sensor will be utilized (e.g., up to about 1,000° C.) and is capable of permitting the electrochemical transfer therethrough of ions generated at one of the electrodes 12 and 14 to the other while inhibiting the physical passage of the unknown gas therethrough. Possible electrolyte materials can comprise metal oxides such as zirconia, and the like, which can optionally be stabilized or partially stabilized with calcium, barium, yttrium, magnesium, aluminum, lanthanum, cesium, gadolinium, and the like, and oxides thereof, as well as combinations comprising at least one of the foregoing electrolyte materials. For example, the electrolyte can be alumina and yttrium-stabilized zirconia. The electrolyte establishes ionic communication between the electrodes disposed on opposite sides thereof.

An electrolyte such as layer 16 with the electrodes 12 and 14 thereon can be formed via many processes (e.g., die pressing, roll compaction, stenciling and screen printing, tape casting techniques, and the like) and can have a thickness of up to about 500 micrometers (μm), e.g., a thickness of about 25 μm to about 500 μm; or a thickness of about 50 μm to about 200 μm.

The sensing electrode 12 comprises materials that are selectively sensitive to ammonia and preferably not sensitive to nitrogen oxides (NO_{X}), carbon monoxide (CO), and hydrocarbons (HC), wherein not sensitive means that the sensor output (e.g., millivolts (mV)) in the presence of NH₃ is substantially the same in the presence of NH₃, NOx, HCs, and CO (i.e., within about ±5%). In other words, when a gas comprising 100 ppm NH₃ is tested, a sensor reading of 140 mV can be obtained. When the same sensor is used to sense a gas comprising 100 parts per million (ppm) NH₃, 1,000 ppm NOx, 100 ppm HC, and 100 ppm CO, the sensor output voltage will be about 133 mV to about 147 mV. As used herein, unless otherwise specified, ppm is part per million and based upon the total molecules of the gas. The difference between the two electrodes in an ammonia-sensing cell causes an electromotive force to be generated when the sensor is placed in a gas stream containing ammonia gas. The resultant electrical potential (or ammonia cell signal) is a function of the ammonia concentration. As described above, the sensing function is based on non-equilibrium Nernstian electrochemical principles.

Disposed on the side of ammonia-sensing cell 12/16/14 opposite insulating support layer 18 are insulating layer(s), e.g., bifurcated insulating support layer 24 comprising a first insulating support layer 26 and a second insulating support layer 28. An insulating layer such as insulating support layer 24 provides structural integrity (e.g., it enhances the physical strength of the sensor), and physically separates and electrically isolates components on either side thereof. For example, support layer 24 can electrically isolate an electrode, such as electrode 14, from another electrode, e.g., electrode 34. An insulating layer can comprise a dielectric material such as alumina (e.g., delta alumina, gamma alumina, theta alumina, and combinations comprising at least one of the foregoing aluminas), and the like.

Aperture 32 in layer 26, like other apertures and open channels described herein, can be formed by perforating or cutting the layer before the layer is incorporated into the sensor element. For manufacturing purposes, the aperture or channel can be filled with fugitive material (not shown) that is later burned away during the manufacture of the sensor element 10. The fugitive material can comprise, for example, carbon, graphite, an insoluble organic material, a polymeric material, or the like. Aperture 32 permits fluid communication of an unknown gas with electrode 14 via an open aperture 33 (FIG. 2) between layer 26 and layer 28 that is open to the unknown gas. Like aperture 32, open aperture 33 is formed upon the removal of fugitive material 30 (FIG. 1) which is deposited between layers 26 and 28 and is later burned away during the manufacture of sensor element 10. Aperture 32 and aperture 33 cooperate to form an aperture configured to permit fluid communication of an unknown gas with an ammonia cell electrode and with an A/F cell electrode, i.e., with the ammonia-sensing cell and with the A/F cell.

On a side of layer 24 opposite ammonia-sensing cell 12/16/14 is an A/F cell 34/38/36 comprising A/F cell electrodes separated by an electrolyte for ionic communication therethrough. More specifically, A/F cell 34/38/36 comprises pump electrodes 34 and 36 (the A/F cell electrodes) disposed on opposite sides of an electrolyte layer 38 (the A/F cell electrode). Electrodes 34 and 36 can comprise any material suitable for oxygen pump electrodes. Possible electrode materials include catalytic metals such as gold (Au), palladium (Pd), rhodium (Ru), platinum (Pt), osmium (Os), ruthenium (Ru), iridium (fr), and the like, and/or alloys and/or oxides comprising at least one of the foregoing materials, and can include other materials. In a particular illustrative embodiment, electrodes 34 and 36 can comprise platinum.

Electrolyte layer 38, like other electrolyte layers referred to herein, can comprise any material that is compatible with the environment in which the gas sensor will be utilized (e.g., up to about 1,000° C.) and is capable of permitting the electrochemical transfer therethrough of ions generated at one of the electrodes 34 and 36 to the other while inhibiting the physical passage of the unknown gas therethrough. The electrolyte establishes ionic communication between the electrodes disposed on opposite sides thereof. Exemplary electrolyte materials include (but are not limited to) zirconia which can optionally be stabilized or partially stabilized with calcium, barium, yttrium, magnesium, aluminum, lanthanum, cesium, gadolinium, and the like, as well as combinations comprising at least one of the foregoing, any of which can be present in oxide form. In a particular illustrative embodiment, electrolyte layer 38 can comprise yttria-partially-stabilized zirconia.

Electrode 34 is in fluid communication with an aperture 40 in layer 28 and thus with the open aperture formed by the fugitive material 30, and thus with electrode 14.

On the side of A/F cell 34/38/36 opposite from ammonia-sensing cell 12/16/14 is an insulating support layer 42 which, in the illustrated embodiment, is bifurcated and comprises a first layer 44 and a second layer 46. First layer 44 has an aperture 48 and second layer 46 has an aperture 50. Apertures 48 and 50 cooperate to provide a gas diffusion chamber in layer 42. A porous material 52 between layer 44 and layer 46 provides a gas diffusion limiting aperture 53 (FIG. 2) which limits gas flow between the unknown gas and apertures 48 and 50. Thus, apertures 48, 50 and 53 cooperate to form an aperture for fluid communication of the unknown gas with A/F cell 34/38/36. Porous material 52 can be formed, for example, from a deposit of a printable ink comprising a mixture of a particulate refractory oxide, e.g., alumina, and a fugitive material onto one of layers 44 and 46. During the manufacture of sensor element 10, the ink is exposed to an elevated temperature and the fugitive material is burned away, leaving a porous aperture of a corresponding shape and known porosity. Other diffusion-limiting apertures or channels disclosed herein can be formed in a similar manner. As a result of apertures 33 and 53, an unknown gas to which sensor element 10 is exposed can contact both A/F cell electrodes. When a constant potential is applied to electrodes 34 and 36, the current through A/F cell 34/38/36 (the A/F cell signal) is limited by the oxygen available via aperture 53 and reflects the partial pressure of oxygen in the unknown gas. Therefore, the A/F cell signal indicates the air-to-fuel ratio of the unknown gas.

On the side of insulating layer 46 opposite from A/F cell 34/38/36 can be an optional electrolyte layer 54, and on the side of layer 54 opposite from layer 42 are insulating layer(s) 56. A heater 60 is disposed on the side of insulating layer 56 opposite from layer 54, between insulating layers 62 and 64. Insulating layer 62 is adjacent insulating layer 56, but there is disposed between them an optional metallic electromagnetic barrier 66 on the side of layer 62 opposite from heater 60. Because heater 60 is part of the monolithic structure of sensor element 10, it is in thermal communication with A/F cell 34/38/36 and ammonia-sensing cell 12/16/14, i.e., heater 60 can be used for maintaining sensor element 10 and the cells therein at a selected working temperature. In other embodiments, a heater could be in thermal communication with the A/F cell and/or with the ammonia-sensing cell without necessarily being part of a monolithic laminate structure with them, e.g., simply by being in close physical proximity to a cell.

Contact pads 68 and 70 comprise electrically conductive material and facilitate electrical communication between sensor element 10 and a sensor circuit that can include sources of current and electrical potential and circuitry responsive to the electrolytic cells in sensor element 10 to indicate the concentration of at least one gas species, as described herein. Several leads are provided in sensor element 10 to provide electrical communication between the control unit and the electrodes and heating member in sensor element 10. Lead 72 is in electrical communication with (e.g., is connected to) sensing electrode 12 and lead 74 is in electrical communication with the reference electrode 14. Similarly, lead 76 is in electrical communication with electrode 34 and lead 78 is in electrical communication with electrode 36. Leads 80 and 82 are in electrical communication with heater 60.

The various leads are in electrical communication with contact pads 68 and 70 through vias such as vias 83 formed in layers 16, 20, 26, 28, 38, 44, 46, 54, 56, 62 and 64. The vias comprise electrically conductive materials and provide a medium for establishing electrical communication between the leads and the contact pads 68 and 70. A via can be formed by perforating the substrate to form a through-hole at a selected position, filling the through-hole with a conducting paste, and curing the conducting paste while the substrate is shaped and cured under heat in a heating/pressing step. The conducting paste can be prepared as a paste using conducting particles, a thermosetting resin solution, and, if necessary, a solvent. The thermosetting resin can be selected from resins that can be cured simultaneously in the step of heating/pressing the substrate. For example, an epoxy resin, thermosetting polybutadiene resin, phenol resin, and/or polyimide resin can be used.

For the conducting particles, a conducting particle-forming powder of a metal material that is stable and has a low specific resistance and low mutual contact resistance is preferably used. For example, a powder of gold, silver, copper, platinum, palladium, lead, tin, and/or nickel, or a combination comprising at least one of the foregoing can be used to form the vias. In one embodiment, the vias are formed at a position on sensor element 10 conveniently distanced from the electrodes, e.g., vias can be formed at one end of sensor element 10 and the opposite end of the sensor element 10 can be the sensing end or tip, at which the electrodes are disposed.

Sensor element 10 and contact pads 68 and 70 can be configured to receive a wiring harness by which electrical communication can be established between sensor element 10 and a sensor circuit. Sensor element 10 can be manufactured using thick film, multi-layer technology including, e.g., the use of strips of commercially suitable alumina, zirconia, etc., for the electrolyte and insulating layers in which vias can be formed as needed and on which electrodes and fugitive compounds thereon can be printed using suitable ink compounds. Such printed tapes can be assembled and fired (e.g., co-fired) into a laminated monolithic (i.e., single structure) sensor element having electronic contact pads on opposite outside surfaces thereof. The disclosed sensor elements can also be built into monolithic structures by bulk ceramic technology, or thick-film multi-layer technology, or thin-film multi-layer technology. In bulk ceramic technology, the sensors are formed in a cup shape by traditional ceramic processing methods with the electrodes deposed by ink methods (e.g., screen printing) and/or plasma method. During formation, the respective electrodes, leads, heater(s), optional ground plane(s), optional temperature sensor(s), optional fugitive material(s), vias, and the like, are disposed onto the appropriate layers. The layers are laid-up and then fired at temperatures of about 1,400° C. to about 1,500° C. Alternatively, the electrodes are not disposed onto the layers. The green layers (including the leads, optional ground plane(s), optional temperature sensor(s), optional fugitive material(s), vias, and the like) are fired at temperatures sufficient to sinter the layers, e.g., temperatures of about 1,400° C. to about 1,500° C. The electrodes are then disposed on the appropriate fired layer(s), and the layers are laid-up accordingly. The sensor element is then again fired at a temperature sufficient to activate the electrode materials, e.g., temperatures of about 700° C. to about 850° C.

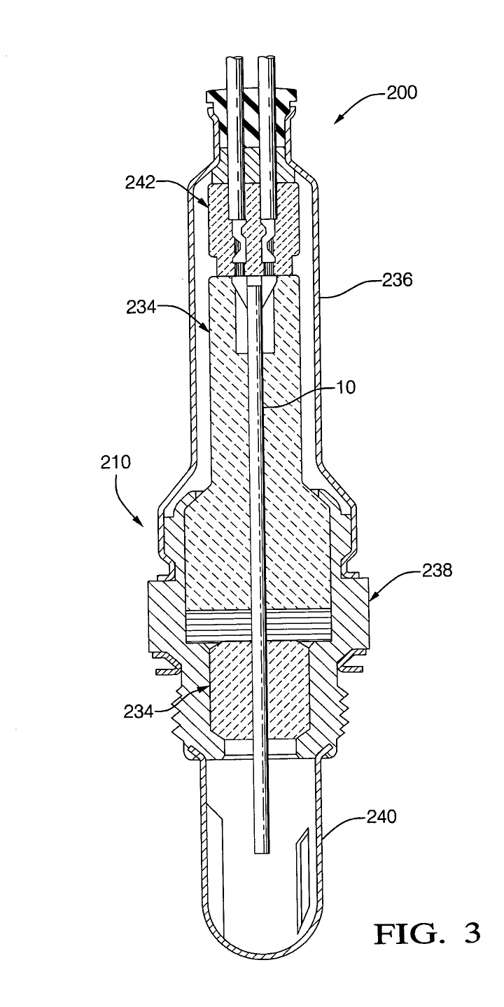

In one mode of use suited for sensing gas species in internal combustion engine exhaust gas, a sensor element such as sensor element 10 can be part of a gas sensor as shown in FIG. 3. In gas sensor 200, sensor element 10 is mounted in a housing 210 by which the sensor element 10 can be secured to a conduit for an unknown gas, e.g., the exhaust pipe of an engine, and which permits the connection of a wiring harness to the sensor. In the embodiment of FIG. 3, the housing comprises an insulator 234, an upper shell 236, a lower shell 238, and an outer shield 240. Sensor element 10 is disposed in an insulator 234, from which the sensing end of sensor element 10 protrudes and from which contact pads 68 and 70 are accessible for connection with a wiring harness 242, which facilitates establishing electrical communication between sensor element 10 and a sensor circuit. Insulator 234 and sensor element 10 are protected in part by a lower shell 238, from which the sensing end of sensor element 10 protrudes, and an upper shell 236, which is mounted on lower shell 238 and through which the wiring harness 242 connected to contact pads 68 and 70 can pass. Outer shield 240 is connected to lower shell 238 to protect the sensing end of sensor element 10, and is configured to permit a surrounding unknown gas to flow therethrough for contact with sensor element 10.

The foregoing description and associated Figures show that sensor element 10 comprises an ammonia-sensing cell, an A/F cell and a heater that are insulated from each other by insulating layers. Housing 210 is configured to permit gas flow therethrough for contact of the unknown gas with sensor element 10 and to permit sensor element 10, i.e., any one or more of A/F cell, ammonia-sensing cell and the heater of sensor element 10, to communicate with a device (e.g., a sensor circuit or control module) outside the housing.

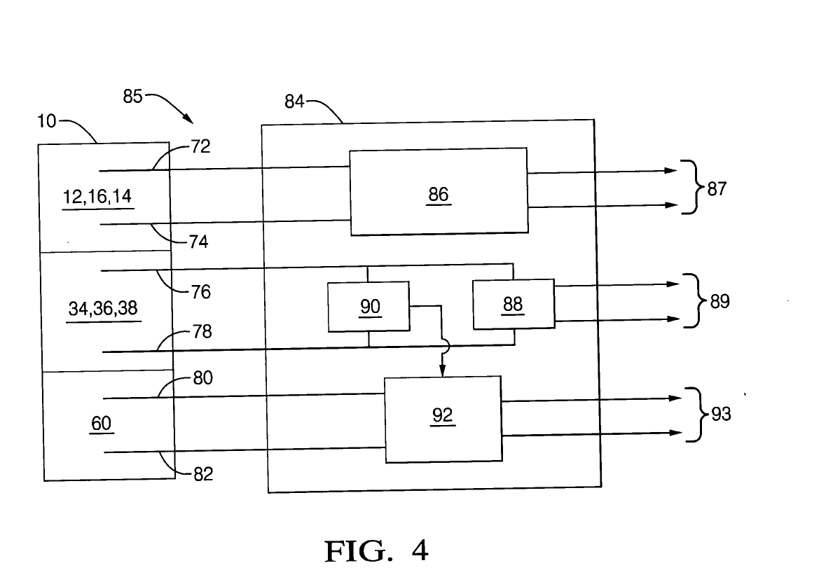

One embodiment of a sensor circuit 84 for use with sensor element 10 to form a sensor system 85 is shown schematically in FIG. 4. Sensor circuit 84 is in electrical communication with leads 72, 74, 76, 78, 80, 82 and the electrodes and heater in communication therewith via contact pads 68, 70 (FIG. 1). Sensor circuit 84 includes an emf signal processing circuit (“emf processor”) 86 in electrical communication with ammonia-sensing cell 12/16/14, and responsive thereto, for generating a signal indicating the content of the sensed species in the unknown gas (the “species gas output signal”), which can be emitted at output 87. Sensor circuit 84 also comprises a DC supply/sensor circuit 88 in electrical communication with A/F cell 34/38/36. DC supply/sensor circuit 88 is configured to provide a constant emf across the electrodes 34 and 36 and to sense the current through A/F cell 34/38/36 and generate a signal at output 89 that indicates the oxygen content or air-to-fuel ratio of the unknown gas. DC supply/sensor circuit 88 can be configured to receive and process, or even to generate, a rich/lean signal.

The EMF of the signal from an ammonia-sensing cell as described herein is affected by the presence of oxygen and water vapor in the unknown gas substantially according to the following equation (1), based on mix-potential theory:

$$EMF \approx \frac{kT}{3 e} Ln ( {P}_{{NH}_{3}} ) - \frac{kT}{4 e} Ln ( {P}_{{O}_{2}} ) - \frac{kT}{2 e} Ln ( {P}_{{H}_{2} O} ) + constant \qquad ( 1 )$$

where k=the Boltzman constant, T=the absolute temperature of the gas, and e is the electron charge unit; Ln(P_{NH}_{₃})=the natural log of the partial pressure of ammonia in the gas, Ln(P_{O}_{₂})=the natural log of the partial pressure of oxygen in the gas and Ln(P_{H}_{₂}_{O})=the natural log of the partial pressure of water vapor in the gas . The oxygen and water vapor content, e.g., partial pressures, in the unknown gas can be determined from the A/F ratio. For example, assuming diesel fuel has an atomic hydrogen to carbon atom ratio H:C of 2:1, then combustion of the fuel in air (in which one part O₂ corresponds to four parts of N₂) will produce exhaust gas as follows:
H₂C+1.5O₂+6N₂+nO₂+4nN₂═H₂O+CO₂+6N₂+nO₂+4nN₂

Given the air-to-fuel (A/F) ratio and assuming there is complete combustion of the fuel, the quantities of water vapor and oxygen remaining in the exhaust gas can be approximated from the relationship in equation (2):

$$\frac{A}{F} = \frac{( 1.5 + n ) ( air density )}{( Fuel volume ) ( Fuel density of ( {H}_{2} C ) )} \qquad ( 2 )$$

Equation (2) can be modified with additional variable to describe deviation from complete combustion, and the parameters of the variables can be stored in or otherwise made available as a virtual look-up table from which signals indicating the oxygen content and water vapor content of the unknown gas can be obtained. Alternatively, a complete mapping of H₂O and O₂ concentrations under all engine running conditions (measured by instrument such as mass spectrometer) can be obtained empirically and stored in ECM (engine control module) in a virtual look-up table with which the sensor circuitry communicates. Once the oxygen and water vapor content information is known, it can be used with the output signal from the ammonia-sensing cell so that a more accurate determination of the ammonia content of the gas can be made. Generally, the presence of oxygen and/or water vapor in the gas will increase or reduce the output signal generated by the ammonia-sensing cell in response to ammonia in the gas, thus leading to an under- or over-estimation of the ammonia content of the gas.

Optionally, T can be obtained from a temperature sensor that indicates the temperature of the ammonia-sensing cell and the A/F cell. By employing the output signal from the A/F sensor, a more accurate determination of the ammonia concentration in the gas can be made from the E output of the ammonia-sensing cell and equation (1). The sensor circuit can be adapted to apply equation (1) (or a suitable approximation thereof) to the signals from the ammonia-sensing cell and the A/F cell, or the sensor circuit can be equipped to access data from data derived from equation (1) or from experiment carried out in an engine dynamometer cell and stored in the nature of a look-up table from which the ammonia concentration can be selected in accordance with the E output from the ammonia-sensing cell and the A/F cell.

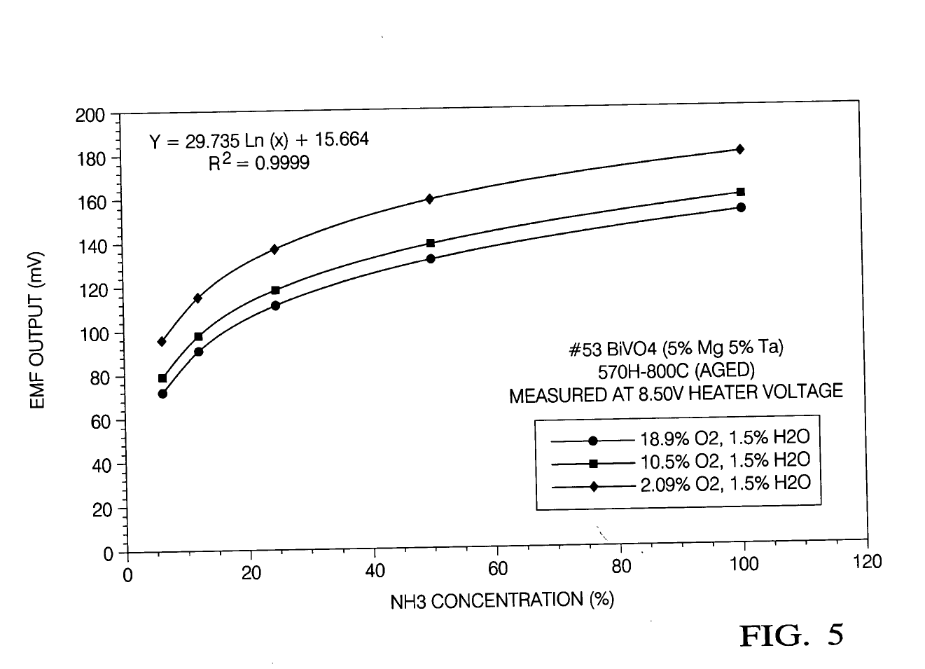

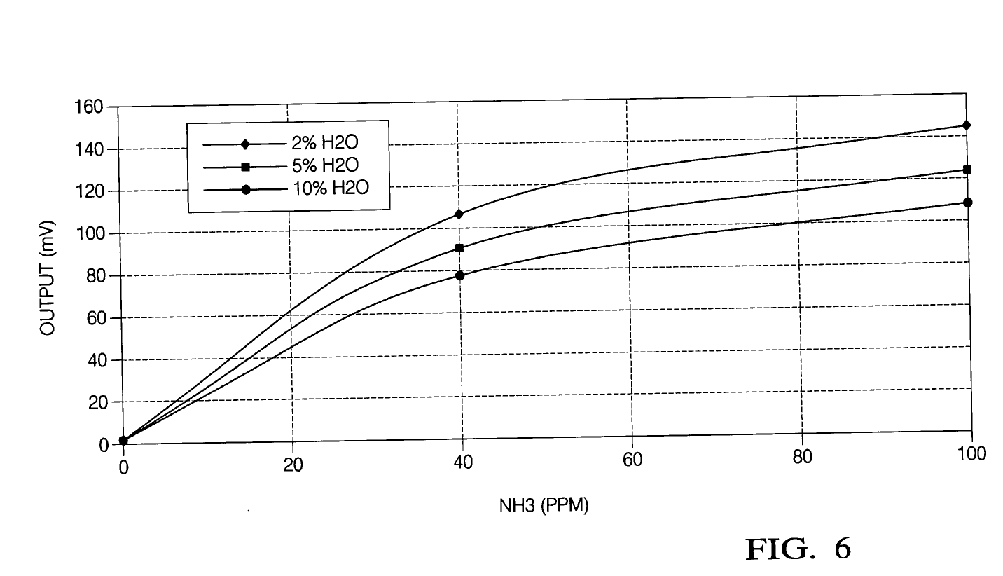

In practice, the affect of oxygen and/or water on EMF can be somewhat smaller than equation (1) predicts. For example, in tests on an ammonia-sensing cell comprising an electrode comprising BiVO₄ with 5 at % Mg and 5 at % Na, the output of an ammonia-sensing cell exposed to a gas containing 18.9% O₂ and 1.5% H₂O by volume (vol %) at a temperature of 650° C. (measured at a heater voltage of 8.5 V) was found to substantially conform to empirical equation (3):
E=29.735 ln(x)+15.664 (3)
where x is the ammonia concentration in parts per million by volume of the gas. This is illustrated graphically in FIG. 5 with plots for E at O₂ concentrations of 18.9 vol %, 10.5 vol % and 2.09 vol % of the tested gas. The data and/or empirical formula represented in FIG. 5 can be employed in place of either equation (1) or a data lookup table based thereon for such an ammonia-sensing cell. Similarly, FIG. 6 illustrates the effect of water vapor on the output of an ammonia-sensing cell comprising a BiVO₄ electrode with 5 at % Na exposed to gases containing ammonia and water vapor levels of 2 vol %, 5 vol % and 10 vol %, with 10 vol % O₂ by volume of the tested gas, at a temperature of 650° C.

Sensor circuit 84 (FIG. 4) can optionally comprise an alternating voltage supply and sensing circuit (VAC supply/sensor circuit) 90 in electrical communication with one of the cells in the sensor element, sometimes referred to herein as a temperature cell. The application of an alternating voltage potential to cell electrodes on either side of an electrolyte material permits sensing of the resistivity (impedance) of the electrolyte material in the vicinity of the electrodes. The resistivity of an electrolyte layer is temperature-dependent, and VAC supply/sensor circuit 90 comprises processing circuitry for sensing the resistivity of the electrolyte layer and for providing a feedback signal to a heater control circuit 92 of sensor circuit 84. The heater control circuit 92 can be configured to adjust the power provided to heater 60 in response to the feedback signal to attain a selected working temperature for sensor element 10. Thus, heater control circuit 92 can be configured to operate in a feedback response mode to modulate the power provided to heater 60. In the illustrated embodiment, VAC supply/sensor circuit 90 communicates with a temperature cell comprising the A/F cell 34/38/36, via leads 76 and 78. VAC supply/sensor circuit 90 is also in electrical communication with a heater control circuit 92, which, in turn, is in electrical communication with heater 60 via leads 80 and 82. VAC supply/sensor circuit 90 is configured to apply an AC potential across A/F cell 34/38/36, from which the resistivity of the electrolyte and can be determined and a signal indicating the temperature of the cell can be generated.

Since the temperature of the sensor element in the vicinity of the electrodes is affected in significant part by the temperature of the gas to which the sensor element is exposed, the resistivity signal and/or the degree of power delivered to the heater by control circuit 92 can be processed as an indirect indication of the temperature of the unknown gas. In this way, the gas-sensing operation of the cell proceeds simultaneously with the operation of the AC sensing function of sensor circuit 84. In an alternative embodiment, the exhaust gas temperature could be measured directly by turning off heater 60, allowing sensor element 10 to reach thermal equilibrium with the exhaust gas, and then measuring the AC resistivity of layer 38.

Sensor circuit 84 can comprise a temperature signal output 93 for providing to other control circuits a signal indicating gas temperature. For example, a temperature signal could be provided to a controller for the engine producing unknown gas, so that engine performance can be adjusted in response to exhaust temperature.

In operation, heater control circuit 92 powers heater 60 to heat sensor element 10 to a working temperature, and sensor element 10 is exposed to an unknown gas. As a result, electrode 12 is disposed in fluid communication with the unknown gas via layer 18, and electrodes 14 and 34 are in fluid communication with the unknown gas via the aperture between layers 26 and 28. Similarly, electrode 36 is in diffusion-limited fluid communication with the unknown gas via material 52.

Sensor circuit 84 applies a voltage to A/F cell 34/38/36, causing oxygen to be pumped from electrode 36 to electrode 34 from where oxygen is emitted via aperture 30 and the open gas aperture 33 (FIG. 2) between layers 28 and 26. The supply of gas to A/F cell 34/38/36 is limited by the diffusion-limiting channel from material 52, and the current through A/F cell 34/38/36 is sensed by DC supply/sensor circuit 88, which provides a quantitative indication of the oxygen content of the exhaust gas at output 89, from which the air/fuel ratio of the gas can be determined. Porous material 52 is sufficiently less porous than material 30 such that the oxygen level at electrode 14 will not much deviate from the oxygen concentration of the exposed gas and equation (1) will not be substantially affected by the extra oxygen emitted at electrode 34. At the same time, VAC supply/sensor circuit 90 (if present) applies an alternating voltage (VAC) to electrodes 34 and 36. The VAC can have a frequency of about 1000 hertz (hz) to about 10 megahertz (Mhz) and an amplitude of about 10 millivolts (mv) to about 2000 mv. VAC supply/sensor circuit 90 senses the resistivity of the electrolyte layer 38 between the electrodes and provides a feedback signal to heater control circuit 92, which is responsive thereto. If the resistivity of layer 38 indicates that sensor element 10 is at a selected working temperature, power to heater 60 can be suspended; otherwise, power to heater 60 can be continued or increased as needed. Optionally, VAC supply/sensor circuit 90 can provide a temperature signal at output 93, for use by other control systems. Meanwhile, the exposure of electrodes 12 and 14 to an unknown gas containing ammonia results in an emf (i.e., voltage potential) between those electrodes 12 and 14 which can be processed by emf processor 86 to yield a quantitative indication of the ammonia content of the exhaust gas at output 87 based on the output signal from ammonia-sensing cell 12/16/14 and the oxygen and water content of the unknown gas, optionally determined from the A/F ratio derived from A/F cell 12/16/14. Hence, the NH₃ concentration, air/fuel ratio, and unknown gas temperature can all be determined from a single sensor. Sensor circuit 84 is configured to generate a signal indicating the NH₃ concentration (the ammonia concentration signal) of the unknown gas. Sensor circuit 84 may also generate a signal indicating the A/F ratio or oxygen content of the unknown gas.

In an alternative embodiment, the VAC can be applied to the ammonia-sensing cell 12/16/14 rather than A/F cell 34/38/36 to obtain the resistivity (impedance) feedback signal.

Should the unknown gas be produced under rich conditions, sensor system 85, operating as just described, can not be able to generate a quantitative indication of the oxygen content or air/fuel ratio therein. At least two methods can be employed to enable sensor system 85 to provide quantitative indications of oxygen or air/fuel ratio under rich conditions in addition to lean conditions by employing a signal that indicates a change from lean to rich conditions. For example, an engine running lean can change to rich conditions for load requirement, and the engine system can be equipped to provide a signal indicating such situation. For such embodiments, sensor circuit 84 can be configured to receive and process a signal that indicates whether the conditions under which the unknown gas was produced have changed from lean to rich or from rich to lean (a “lean/rich signal”), e.g., a signal from an ECM (engine control module) indicating that the heavy load is required. Optionally, the lean/rich signal can be obtained from a sensing cell specific to a gas species whose levels depend on whether the engine is operating under lean or rich conditions, and such sensing cell can be contained within the sensor element. For example, HC is produced in greater quantities during rich operation than during lean operation-. Accordingly, the lean/rich signal for sensor system 85 can be produced therein in response to a signal from a HC-sensing cell in communication therewith.

In some embodiments, either sensor circuit 84 can be configured to respond to the lean/rich signal indicating a change to rich conditions by reversing the polarity of the voltage applied to electrodes 34 and 36 from that normally applied during lean conditions, thus causing oxygen to pump from electrode 34 to electrode 36. The flow will be limited by the fuel gas flux supplied via the gas diffusion limiting aperture 52. The current through A/F cell 34/38/36 can be processed by DC supply/sensor circuit 88 in response to the lean/rich signal to provide a quantitative indication of the oxygen content or air/fuel ratio of the unknown gas even though the gas is rich.

In an alternative embodiment suited for both lean and rich condition operation, a sensor element is similar to sensor element 10, except that electrode 14 and electrode 34 do not share a common aperture such as aperture 30. Instead, there is an insulation layer between electrodes 14 and 34 and each of these electrodes has its own aperture for access to the unknown gas, and. In such an embodiment, the aperture for electrode 14 can have a greater gas-diffusion-limiting characteristic than the aperture for electrode 36. Accordingly, sensor circuit 84 need not reverse the polarity on electrodes 34 and 36 upon receiving the rich operation signal, and oxygen can continue to be pumped from electrode 36 to electrode 34. In rich conditions, the pumped oxygen will be limited by the amount of fuel gas that can reach electrode 34 through the aperture associated therewith, and the limited current through A/F cell 34/38/36 indicates the oxygen concentration or air/fuel ratio of the unknown gas. In lean conditions, the pumped oxygen will be limited by the amount of oxygen that can reach electrode 36 through the aperture corresponding to that provided by material 52. DC supply/sensor circuit 88 will be responsive to the lean/rich signal so that a quantitative indication of oxygen concentration can be made under rich conditions as well as under lean conditions.

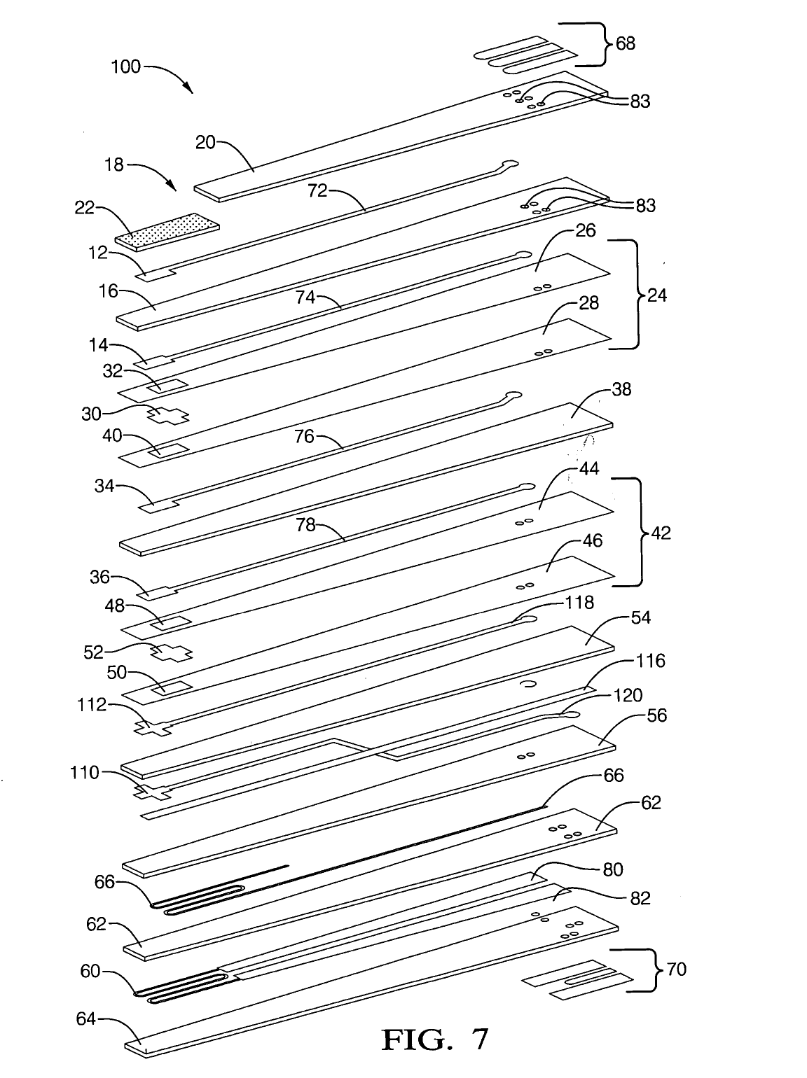

In FIG. 7, a sensor element according to another embodiment is shown. Sensor element 100 comprises many of the same structural elements as sensor element 10 of FIG. 1, and the like elements in sensor element 100 are numbered as they were in sensor element 10. Like sensor element 10, sensor element I 00 can be manufactured using thick film multi-layer technology. In contrast to sensor element 10, sensor element 100 comprises an air/fuel (A/F) reference cell comprising a first reference electrode 110 and a second reference electrode 112 (the reference cell electrodes) on either side of a solid electrolyte layer 54 (the reference electrolyte) for ionic communication therethrough. A/F reference cell 110/54/112 is insulated from the other cells and from the heater by insulating support layers on either side. Electrode 112 is exposed to the gas diffusion limiting aperture 53 between layers 44 and 46 via aperture 50 in layer 46. Reference electrode 110 is exposed to a reference gas of predetermined oxygen content (e.g., air) via an air channel between layers 54 and 56 formed by fugitive channel material 116. A/F reference cell is insulated from other cells and from the heater by insulation layers 42 and 56.

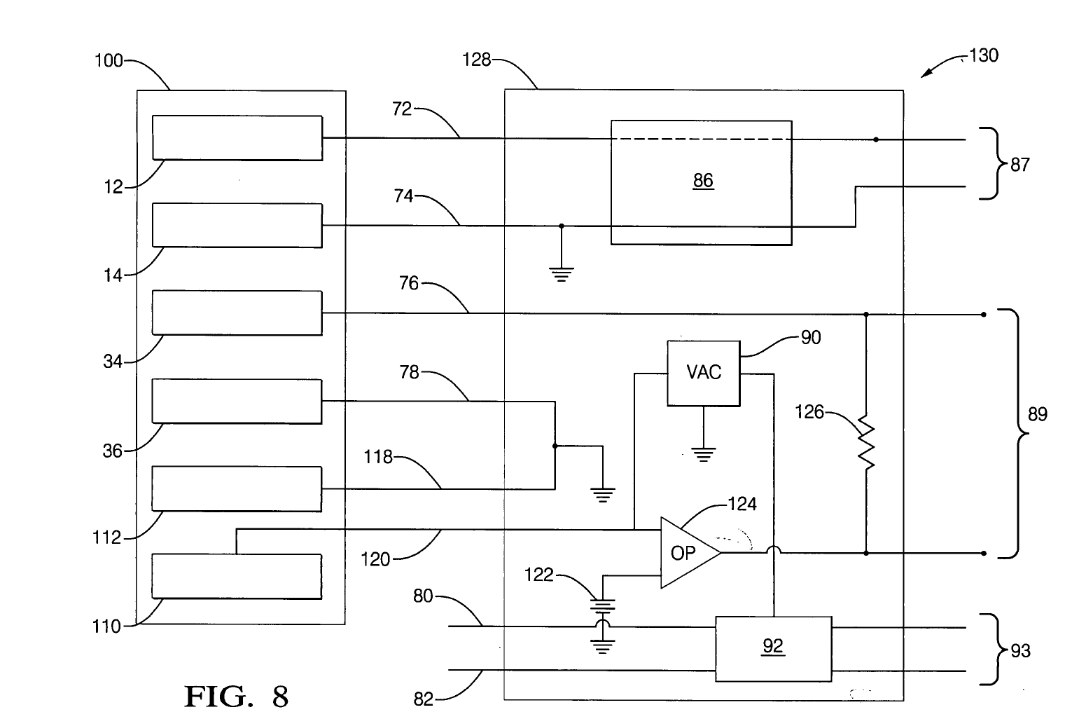

Sensor element 100 can be used in a sensor in combination with a sensor circuit 128 to produce a sensing system 130, FIG. 8. As shown in FIG. 8, ammonia-sensing cell 12/16/14 communicates with emf processor 86 via leads 72 and 74, and a signal indicative of the concentration of ammonia gas is provided at output 87. Reference electrode 110 communicates with operational amplifier (op-amp) 124, and reference electrode 112 and pump electrode 36 are commonly grounded. Output 89 (indicating the oxygen content or air/fuel ratio of the unknown gas) is provided by pump electrode 34 and the output of op-amp 124, which are in mutual communication via a region of resistance 126. A VAC supply/sensor circuit 90 communicates with electrode 110 and has a common ground with electrode 112. A heater control circuit 92 communicates with heater leads 80 and 82 and receives a feedback signal from VAC supply/sensor 90. A shield such as shield 240 (FIG. 3) can be commonly grounded with a heater such as heater 60. A common ground for two or more leads from the sensor element can be established in the sensor circuit or in the sensor element (by disposing the leads in electrical communication with a common via). Heater control circuit 92 provides an output temperature signal at 93. Sensing system 130 is capable of indicating the oxygen content or air-to-fuel ratio of the unknown gas during both lean and rich conditions, as well as an unknown gas component concentration and an unknown gas temperature.

By designing a sensor and sensor element as discussed above, improved sensing of ammonia in unknown gases is achieved. Optionally, a single sensor can be employed to determine gas temperature, air/fuel ratio, and/or the concentration of ammonia or another gas component (e.g., NOₓ, HC, CO, or the like), thus reducing the number of sensors needed to determine these parameters and simplifying the control circuitry for an exhaust system and reducing component costs. The sensor element can comprise separate cells for each function (temperature determination, air/fuel ratio determination, ammonia concentration, etc.), or a cell can be used to perform more than one function (e.g., temperature detection, A/F ratio, etc.) as described above.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gas sensor system comprising:
an ammonia-sensing cell for generating an ammonia cell signal upon exposure to an unknown gas comprising ammonia;
an A/F cell for generating an A/F cell signal upon exposure to hydrocarbons in the unknown gas;
a heater in thermal communication with the ammonia-sensing cell and with the A/F cell; and
a housing in which the ammonia-sensing cell, the A/F cell and the heater are mounted, the housing being configured to permit the flow of the unknown gas therethrough for contact with the ammonia-sensing cell and with the A/F cell; and
a sensor control circuit in communication with the A/F cell and the ammonia-sensing cell;
wherein the sensor control circuit is configured to utilize the ammonia cell signal and the A/F cell signal to generate an ammonia concentration signal indicating the concentration of ammonia in the unknown gas.

2. The sensor system of claim 1, comprising a monolithic sensor element that comprises the ammonia-sensing cell, the A/F cell and the heater.

3. The sensor system of claim 2, wherein the ammonia-sensing cell comprises an ammonia cell electrolyte and ammonia cell electrodes in mutual ionic communication via the ammonia cell electrolyte, and wherein the A/F cell comprises an A/F cell electrolyte and A/F cell electrodes in mutual ionic communication via the A/F cell electrolyte, and further comprising an insulating support layer between the ammonia-sensing cell and the A/F cell, wherein the insulating support layer comprises an aperture configured to permit fluid communication of the unknown gas with the ammonia cell and with the A/F cell.

4. The sensor system of claim 2, further comprising an A/F reference cell in the monolithic sensor element, the A/F reference cell comprising a reference cell electrolyte and reference cell electrodes in mutual ionic communication via the reference cell electrolyte.

5. The sensor system of claim 4, further comprising an insulating support layer between the A/F cell and the A/F reference cell, the insulating support layer comprising an aperture configured to permit fluid communication of the unknown gas with the A/F reference cell and with the A/F cell.

6. The sensor system of claim 1, wherein the ammonia cell signal comprises an EMF and wherein the sensor control circuit generates the ammonia concentration signal substantially according to the formula
$$EMF \approx \frac{kT}{3 e} Ln ( {P}_{{NH}_{3}} ) - \frac{kT}{4 e} Ln ( {P}_{{O}_{2}} ) - \frac{kT}{2 e} Ln ( {P}_{{H}_{2} O} ) + constant ;$$
wherein k=the Boltzman constant, T=the absolute temperature of the gas, and e is the electron charge unit; Ln(P_{NH}_{₃})=the natural log of the partial pressure of ammonia in the gas, Ln(P_{O}_{₂})=the natural log of the partial pressure of oxygen in the gas and Ln(P_{H}_{₂}_{O})=the natural log of the partial pressure of water vapor in the gas.

7. The sensor system of claim 1, wherein the sensor control circuit is disposed outside the housing.

8. The sensor system of claim 1, wherein the sensor control circuit is in communication with the heater, to power the heater.

9. The sensor system of claim 1, wherein the sensor control circuit comprises a VAC supply/sensor circuit for applying an alternating current to a cell in the housing whereby such cell comprises a temperature cell, and for generating a temperature signal that indicates the temperature of the temperature cell.

10. The sensor system of claim 9, wherein the sensor control circuit is configured to provide power to the heater in response to the temperature signal.

11. The sensor system of claim 9, wherein the temperature cell is the A/F cell or the ammonia-sensing cell.

12. A method for sensing ammonia in an unknown gas, comprising:
heating an ammonia-sensing cell and an A/F cell to selected working temperatures;
exposing the ammonia-sensing cell and the A/F cell to an unknown gas;
obtaining an ammonia cell signal from the ammonia-sensing cell;
obtaining an A/F cell signal from the A/F cell; and
using the ammonia cell signal and the A/F cell signal to determine the ammonia content of the unknown gas.

13. The method of claim 12, comprising exposing the unknown gas to a gas sensor that comprises a monolithic sensor element that comprises the ammonia-sensing cell and the A/F cell.

14. The method of claim 12, comprising using the A/F cell signal to determine P_{O}_{₂} and P_{H}_{₂}_{O} in the unknown gas, wherein the ammonia cell signal comprises an EMF, and wherein the method comprises generating an ammonia concentration signal indicating the concentration of ammonia in the unknown gas derived substantially according to the formula
$$EMF \approx \frac{kT}{3 e} Ln ( {P}_{{NH}_{3}} ) - \frac{kT}{4 e} Ln ( {P}_{{O}_{2}} ) - \frac{kT}{2 e} Ln ( {P}_{{H}_{2} O} ) + constant ;$$
wherein k=the Boltzman constant, T=the absolute temperature of the gas, and e is the electron charge unit; Ln(P_{NH}_{₃})=the natural log of the partial pressure of ammonia in the gas, Ln(P_{O}_{₂})=the natural log of the partial pressure of oxygen in the gas and Ln(P_{H}_{₂}_{O})=the natural log of the partial pressure of water vapor in the gas.

15. The method of claim 14, comprising calculating P_{O}_{₂} and P_{H}_{₂}_{O} from the A/F cell signal.

16. The method of claim 14, comprising using the A/F cell signal to retrieve P_{O}_{₂} and P_{H}_{₂}_{O} from a virtual look-up table.
